(19) United States
(12) Patent Application Publication
(10) Pub. No.: US 2006/0249883 A1
(43) Pub. Date: Nov. 9, 2006

(54) Folding and forming apparatus and method of prepreg

(75) Inventors: Yoshitomo Oguma, Tokyo (JP); Hideyuki Jingu, Tokyo (JP)

Correspondence Address: SMITH, GAMBRELL & RUSSELL, 1850 M STREET, N.W., SUITE 800, WASHINGTON, DC, 20036, US

(73) Assignee: Fuji Jukogyo Kabushiki Kaisha

(21) Appl. No.: 11/418,139

(22) Filed: May 5, 2006

(30) Foreign Application Priority Data
May 9, 2005 (JP) P. 2005-135480

(51) Int. Cl. B29C 47/76

(52) U.S. Cl. 264/339; 264/101; 425/405.1

(57) ABSTRACT

A prepreg is put on upper faces of a protruding jig and heaters arranged on and lifters. A vacuum bag covers upper portions of the protruding jig and the lifters together with the prepreg. The vacuum bag is fixed to flanges of a box-shaped jig. Then, a closed space including a space covered by the vacuum bag and a space communicated with the space covered by the vacuum bag is vacuumed. Then, the heaters are energized with electricity so as to heat and soften portions of the prepreg positioned on the lifters. After the portions have been softened, the lifters are lowered so as to fold and form the prepreg. Thereby, a product can be obtained in which no wrinkles are generated in folded portions.

The present application claims foreign priority based on Japanese Patent Application No. P.2005-135480, filed on May 9, 2005, the contents of which are incorporated herein by reference.

### BACKGROUND OF THE INVENTION

1. Field of the Invention

The present invention relates to an apparatus and a method for folding and forming a prepreg suitable for a laminated prepreg, especially a prepreg with a large laminating thickness.

### Related Art

Disclosed in JP-Y-05-014834 is a folding and forming apparatus of composite material (prepreg) in which a folding and forming process is automated so as to stabilize a quality of products.

As shown in FIG. 3A, the apparatus 100 is structured as follows. At the center of a housing 102 arranged in a bed 101, a mandrel 104 is attached via support legs 103. A pair of side blocks 105, which can be moved upward and downward, are respectively attached to both sides of the mandrel 104. On the support legs 103 of the mandrel 104, a heater 106 for heating the mandrel 104 is attached. On an upper surface formed on the mandrel 104 and the side blocks 105, a prepreg W₁, which is laminated, is put. In order to fold and form the prepreg W₁, a tightly closed space 108 is formed by a vacuum bag 107 as shown in FIG. 3B, and the mandrel 104 is heated by the heater 106 so as to soften the prepreg W₁. After the prepreg W₁ has been softened, the tightly closed space 108 is sucked so that air is discharged from the tightly closed space 108. Then, the side blocks 105 are lowered so that the prepreg W₁, is folded and formed.

In the above folding and forming apparatus of composite material, the mandrel is heated and a portion of the prepreg positioned on the mandrel is softened by the heat of the mandrel, so that the prepreg is folded and formed. According to the method, when a thickness of the laminated prepreg is relatively small, no problems are caused in quality of the prepreg. However, when the thickness of the laminated prepreg is large, small stripes, that is, so-called wrinkles are caused in an R-portion (a folded portion), which causes problems in quality of the formed prepreg. Therefore, in order to fold and form a thickly laminated prepreg, by heating not only the mandrel but also the side blocks by the heat of the mandrel, another way of saying the entire apparatus or conducting the folding and forming not continuously but stepwise, a generation of wrinkles is prevented, in the conventional apparatus. However, when the entire apparatus is heated or folding and forming are conducted stepwise, it takes time to heat or to conduct folding and forming. Accordingly, the running cost is raised.

### SUMMARY OF THE INVENTION

One or more embodiments of the present invention provide an apparatus and a method for folding and forming a prepreg, in which it is prevented from increasing a running cost caused by the prolonged heating time and the prolonged folding and forming time and stabilized quality of the prepreg is obtained, even if a thickness of the laminated prepreg is large.

In accordance with one or more embodiments of the present invention, a folding and forming apparatus of prepreg is provided with: a protruding jig with two flat side surfaces opposed to each other; a pair of lifters respectively provided adjacent to the sides of the protruding jig and capable of moving with respect to the protruding jig; and a pair of heaters respectively arranged on upper faces of the lifters. In addition, the apparatus may further be provided with a suction device for drawing air from a closed space formed by a vacuum bag covering the protruding jig and the lifters. In the apparatus, a prepreg before folding is put on an upper face of the protruding jig and the upper faces of the lifters, and after a portion of the prepreg disposed on at least one of the lifters has been heated and softened, the prepreg is folded and formed. Therefore, a slippage is caused in the folded portion of the prepreg, and the generation of wrinkles can be suppressed. Accordingly, even if a laminated prepreg has a large thickness, it is possible to obtain stable quality. Therefore, of course, such a problem that the running cost is increased due to the prolonged heating time and the prolonged folding and forming time is not caused, which is unlike the conventional case.

Further, in accordance with one or more embodiments of the present invention, a folding and forming apparatus of prepreg may further be provided with a box-shaped jig for accommodating the protruding jig and the lifters while upper portions of the protruding jig and the lifters are being protruded from the box-shaped jig. Due to the foregoing, a range of suction by vacuum is limited. Therefore, a period of time necessary for conducting a vacuum suction can be reduced.

In addition, in accordance with one or more embodiments of the present invention, a method of folding and forming a prepreg is provided with: putting a prepreg on an upper face formed by a protruding jig and a pair of lifters, wherein the protruding jig includes two flat side surfaces opposed to each other and the lifters are respectively arranged adjacent to the sides of the protruding jig; forming a closed space by covering the upper portion by a vacuum bag; heating and softening a portion of the prepreg positioned on at least one of the lifters by a heater arranged on the one of the lifters; and lowering the one of the lifters after the portion of the prepreg has been softened, so as to fold and form the prepreg. According to the above method, when a laminated prepreg, even though the thickness of which is large, is folded and formed, it is possible to stably obtain a product of high quality without an increase in the running cost caused by the prolonged heating time and the prolonged folding and forming time.

According to a folding and forming apparatus and a method of prepreg of one or more embodiments of the present invention, a portion of the prepreg positioned on a lifter, is heated and softened, and then the prepreg is folded and formed. Therefore, a slippage is generated in the folded portion of the prepreg and the occurrence of wrinkles is suppressed. Accordingly, when a layer of prepreg, even though the lamination thickness of which is large, is folded and formed, it is possible to stably obtain a product of high quality without an increase in the running cost caused by the prolonged heating time and the prolonged folding and forming time.

Other aspects and advantages of the invention will be apparent from the following description and the appended claims.

### BRIEF DESCRIPTION OF THE DRAWINGS

FIG. 1 is an arrangement view showing a folding and forming apparatus of prepreg of an exemplary embodiment of the present invention.

FIG. 2A is a schematic illustration for explaining operation of the apparatus shown in FIG. 1.

FIG. 2B is a perspective view showing a product obtained by folding and forming the prepreg.

FIG. 3A is a perspective view showing a conventional composite material folding and forming apparatus.

FIG. 3B is a cross-section view of the conventional composite material folding and forming apparatus of FIG. 3A.

### DETAILED DESCRIPTION OF THE EXEMPLARY EMBODIMENTS

Exemplary embodiments of the invention will be described with reference to the accompanying drawings.

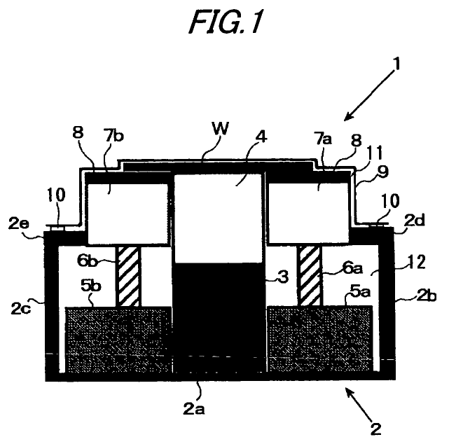

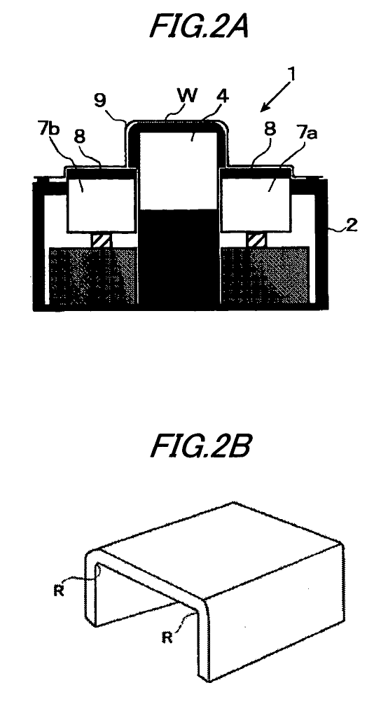

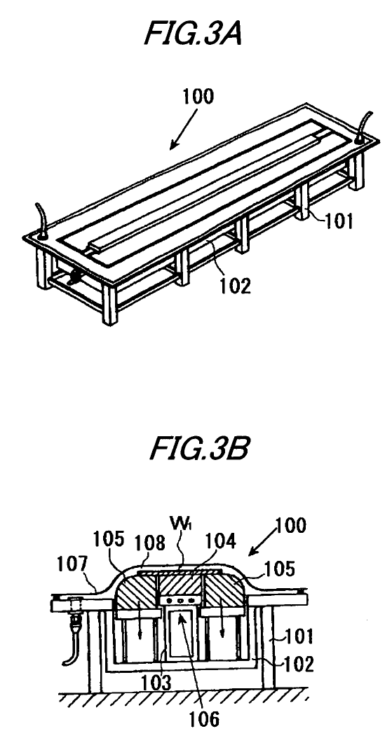

A folding and forming apparatus 1 of prepreg of the present exemplary embodiment folds and forms a laminated prepreg W including a laminated prepreg with a large thickness, so as to form the laminated prepreg W into a reverse-U-shaped member shown in FIG. 2B. As shown in FIG. 1, the folding and forming apparatus 1 of prepreg has a box-shaped jig 2. The box-shaped jig 2 includes: a bottom plate 2a of a long size; side plates 2b, 2c vertically arranged at both end portions of the bottom plate 2a; and flanges 2d, 2e of a short size protruding from upper end portions of the side plates 2b, 2c being opposed to each other. A gap between the flanges 2d and 2c forms an opening portion of the box-shaped jig 2. The box-shaped jig 2 accommodates a protruding jig 4 and lifters 7a, 7b, which will be described later, in such a manner that upper portions of the protruding jig 4 and the lifters 7a, 7b are protruded from the opening portion between the flanges 2d and 2c.

On a jig stand 3 provided at a center of the bottom plate 2a of the box-shaped jig 2, the protruding jig 4 is arranged. On the other hand, on both sides of the jig stand 3, lifter stands 5a, 5b, on which screw shafts 6a, 6b are vertically arranged, are provided. The heights of the lifter stands 5a, 5b are somewhat smaller than the height of the jig stand 3, and lifters 7a, 7b, which are screwed to the screw shafts 6a, 6b, are arranged being capable of moving upward and downward along the screw shafts 6a, 6b. In other words, the lifters 7a, 7b are arranged so that they can be moved by the screw shafts 6a, 6b with respect to the protruding jig 4.

In this exemplary embodiment, on upper faces of the lifters 7a, 7b, heaters (heating devices) 8 are arranged for heating the laminated prepreg W. The lifters 7a, 7b are accommodated in the box-shaped jig 2 in such a manner that the lifters 7a, 7b are arranged being adjacent to two flat side surfaces, which are opposed to each other, of the protruding jig 4, and upper portions of the lifters 7a, 7b are protruded from the opening portion of the box-shaped jig 2 together with the upper portion of the protruding jig 4.

In this connection, the flanges 2d and 2e of the box-shaped jig 2 are used as a receiving stand for receiving a vacuum bag 9 which is fixed by a sealant 10. As described later, the vacuum bag 9 is a bagging film for covering the upper portion of the protruding jig 4, on which the prepreg W is put, and for covering the upper portions of the lifters 7a, 7b together with the prepreg W. A portion covered with the film is formed into a space 11. This space 11 is communicated with the space 12 divided inside the box-shaped jig 2. These spaces 11, 12 form a tightly closed space which is sucked with vacuum by a suction device, for example, by a vacuum pump.

Next, explanations will be made into a folding and forming method of prepreg in which the apparatus 1 of the exemplary embodiment is used.

In the apparatus 1, on the upper faces of the protruding jig 4 and the lifters 7a, 7b, to be more specific, on the upper faces of the protruding jig 4 and the heaters 8 on the lifters 7a, 7b, the laminated prepreg W is disposed. Then, together with the prepreg W, the upper portions of the protruding jig 4 and the lifters 7a, 7b, on which the W is disposed, are covered with the vacuum bag 9, and this vacuum bag 9 is fixed to the flanges 2d and 2e of the box-shaped jig 2. Then, the closed space including the space 11 covered with the vacuum bag 9 and the space 12 communicated with the space 11, is sucked so as to discharge air from the closed space. Due to the suction, the vacuum bag 9 comes close contact with the prepreg W. Therefore, a region of the space 11 is substantially eliminated. Then, the heater is turned on. Therefore, portions of the prepreg W positioned on the lifters 7a, 7b are heated to a predetermined temperature and softened. After the portion of the prepreg W has been softened, the lifters 7a, 7b are respectively lowered to the state shown in FIG. 2A. In this connection, when the lifters 7a, 7b are lowered in this way, portions of the prepreg W positioned on the lifters 7a, 7b, that is, portions of the prepreg W to become R-portions (corner portions) and bent portions in outer sides of the R-portions, are folded while copying corner portions of the protruding jig 4. However, according to the method of the present exemplary embodiment, since the portions of the prepreg, which are folded when the lifters are lowered, are heated, a slippage is caused in each folded portion. As a result, the occurrence of wrinkles in the folded portion can be suppressed. According to the method of the exemplary embodiment, even when the lamination thickness of the prepreg W is large, no wrinkles are caused in the folded portion. Therefore, it is possible to stably obtain a product of high quality.

After the lifters 7a, 7b have been lowered, the vacuum bag 9 is detached, and a formed product made from the prepreg W as shown in FIG. 2B, is picked up. Of course, no wrinkles are generated in the R-portions (folded portions) of the product picked up in this way.

In this connection, in the present exemplary embodiment, explanations are made into a case in which both lifters 7a, 7b are lowered and a product is formed as shown in FIG. 2B. However, of course, it is possible to form, for example, an L-shaped product when only one of the lifters 7a, 7b is lowered. In this case, of course, it is possible to stably obtain a product of high quality in which no wrinkles are generated in R-portion(s) (folded portion(s)) of the product.

In the folding and forming apparatus and method of prepreg of the embodiments, a portion of a prepreg positioned on a lifter, is heated and softened and then the prepreg is folded and formed. Therefore, even when a lamination thickness of the prepreg is large, no wrinkles are generated and a product of stable quality can be folded and formed. Therefore, the folding and forming apparatus of prepreg of the present invention and the folding and forming method thereof can be effectively put into practical use.

It will be apparent to those skilled in the art that various modifications and variations can be made to the described preferred embodiments of the present invention without departing from the spirit or scope of the invention. Thus, it is intended that the present invention cover all modifications and variations of this invention consistent with the scope of the appended claims and their equivalents.

What is claimed is:

1. A folding and forming apparatus of prepreg comprising:
a jig and a first lifter for holding a prepreg thereon, wherein the first lifter is provided adjacent to the jig and capable of moving with respect to the jig;
a heater arranged to heat a prepreg portion supported by the first lifter; and
a suction device for drawing air from a space formed by a covering layer covering the jig and the first lifter.

2. The apparatus according to claim 1, further comprising:
a second lifter provided on an opposed side of the first lifter relative to the jig.

3. The apparatus according to claim 1, wherein the jig comprises a pair of flat side surfaces; and
the first lifter and the second lifter are adjacent to the respective flat side surfaces.

4. The apparatus according to claim 1, further comprising:
an another heater supported by the second lifter.

5. The apparatus according to claim 4, wherein the heaters are respectively provided on upper surfaces of the first lifter and the second lifter.

6. The apparatus according to claim 1, further comprising:
a box jig for accommodating the jig and the first lifter and the second lifter, wherein upper portions of the jig and the first lifter the second lifter are protruded from the box jig.

7. The apparatus according to claim 1, wherein a closed room is formed by the covering layer.

8. A method of folding and forming a prepreg comprising:
setting a prepreg on a jig and a lifter adjacent to the jig;
creating a space by covering the prepreg by a covering layer;
drawing air from the space;
heating a portion of the prepreg supported by the lifter; and
moving the lifter after the portion of the prepreg has been softened, so as to fold and form the prepreg into a predetermined shape.

9. The method according to claim 8, wherein the portion of the prepreg is heated by a heater supported by the lifter.

10. The method according to claim 9, wherein the heater is provided on an upper surface of the lifter.

11. The method according to claim 5, wherein the prepreg is heated while the lifter is moving.
